(19) United States
(12) Patent Application Publication
(10) Pub. No.: US 2009/0219992 A1
(43) Pub. Date: Sep. 3, 2009

(54) Compensating delay of channel state information between receiver and transmitter during adaptive video delivery

(76) Inventor: Charles Chunaming Wang, Beijing (CN)

Correspondence Address: Thomson Licensing LLC, P.O. Box 5312, Two Independence Way, PRINCETON, NJ, 08543-5312, US

(21) Appl. No.: 11/989,674

(22) PCT Filed: Jun. 30, 2006
(86) PCT No.: PCT/US06/26048

§ 371 Date: Jan. 29, 2008

Related U.S. Application Data
(60) Provisional application No. 60/705,621, filed on Aug. 4, 2005.

(51) Int. Cl. H04N 7/26; G06F 15/16; H04L 12/26

(52) U.S. Cl. 375/240.03; 709/231; 375/240.27; 375/E07.126; 375/E07.139; 370/230.1

(57) ABSTRACT

A method for controlling transmission of video data in a network, including: transmitting video data to a receiver via the network; receiving channel parameter information measured by the receiver; applying a predictive function to the channel parameter information to compensate for delay times in receiving the channel parameter information from the receiver, and generating a feedback function; and adjusting the video data to be transmitted in response to the feedback function to compensate for network conditions.

### FIELD OF THE INVENTION

The invention relates generally to data delivery, and more particularly to digital multimedia content delivery for use with a network including one or more wired or wireless links.

### BACKGROUND OF THE INVENTION

Delivering audio/visual multimedia content over a wired and/or wireless network has many challenges. In a wireless network, challenges for real-time video streaming include time-varying fluctuations in wireless channel quality and high bit error rates, as compared to wired links. Adaptive multimedia content delivery over a network channel employing feedback from the receivers may be viable if the adaptation can closely follow the channel variations in time. However, due to the delay in feeding back information, caused by the limited bandwidth of the feedback channel for example, adaptation typically lags channel measurements. In control systems, this delay time is sometimes known as “dead time”. Conventional video adaptation algorithms do not take dead time into account. As a result, systems using adaptation may introduce unwanted overcompensation based on the delayed feedback information.

Although delay time in the channel information feedback is a known problem, particularly in content delivery over a network, no known solutions have been proposed. Accordingly, it is believed to be desirable to provide a controller, based on control theory, in a feedback/adaptation loop that addresses feedback delay and dead time in the video delivery network.

### SUMMARY OF THE INVENTION

An exemplary method according to the invention is a method for controlling transmission of video data in a network, including: transmitting video data to a receiver via the network; receiving channel parameter information measured by the receiver; applying a predictive function to the channel parameter information to compensate for delay times in receiving the channel parameter information from the receiver, generating a feedback function; and adjusting the video data to be transmitted in response to the feedback function to compensate for network conditions. An exemplary system for implementing the method is also disclosed.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts and in which:

FIG. 1 is a simplified block diagram of a feedback control system;

FIG. 2 is a simplified block diagram of an end-to-end video delivery system;

FIG. 3 is a simplified block diagram of a PID control system;

FIG. 4 is a simplified block diagram of a Smith Predictor control system;

FIG. 5 is a simplified block diagram of an end-to-end video delivery system;

FIG. 6 is a flow diagram of a control process well-suited for use with a wireless digital multimedia content delivery system.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical digital multimedia content delivery methods and systems. However, because such elements are well known in the art, a detailed discussion of such elements is not provided herein. The disclosure herein is directed to all such variations and modifications known to those skilled in the art.

Digital multimedia content may be delivered to a media consumer, e.g., a decoder/television or combination, over a network, for example a wireless channel, characterized by time-varying fluctuations in channel quality and high bit error rates. To cope with the time-varying characterization of the channel, information related to the channel conditions may be fed from the receiver back to the transmitter, to adjust the video stream(s) generated at the transmitter end. For example, as the available bandwidth varies with time, the receiver may measure or estimate available bandwidth between the transmitter and receiver, and send that information back to the transmitter, which may then instruct a video encoder to adjust one or more data parameters, such as quantization parameters, to generate a bit-stream at a rate appropriate to the available bandwidth. Another example of adaptation is varying the amount of redundancy in the form of Forward Error Correction (FEC) added to the underlying multimedia context transmitted to the receiver. With increasing packet loss probability in a wireless channel, more FEC redundancy may be applied so that the receiver may for example recover the lost packets.

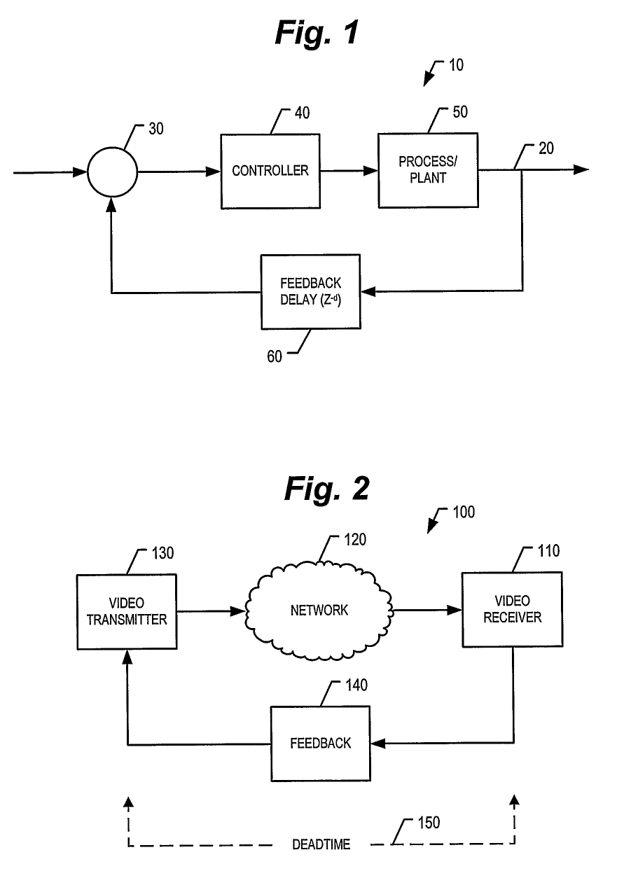

Referring now to FIG. 1, there is shown a block representation of an end-to-end video delivery system 10. Therein, receiver 20 conventionally measures wireless channel 30 parameters, such as available bandwidth, delay time and packet loss probability, and feeds channel parameter information back to the transmitter 40 via a feedback channel 50. The elapsed time between the receiver 20 measuring the channel parameters and the transmitter 40 receiving those parameters is the dead time 60 for the video delivery system 10. This dead time may vary depending on the bandwidth of the feedback channel. In an unreliable feedback channel, some of the feedback information may even get lost. Based on the feedback information, the video encoder in the transmitter may take action to accommodate the varying channel conditions (e.g. to adapt the generated bit rate of the encoded video stream). The loop may be considered as a simple proportional control loop. The error (e.g. difference) between the target and feedback is scaled by a factor (e.g. proportional value) to control the upcoming generated bit rate. If the dead time is considerably long compared with the channel varying time, the action taken by the transmitter will be too late. It will have already overcompensated for the much earlier channel conditions. If the channel conditions change, the action taken by the transmitter may cause an even larger error in the opposite direction. This phenomenon in known as overcompensation in control theory. As a result, the actual output may become unstable, and an oscillation may result.

Control theory suggests a number of solutions for compensating for dead time and overcompensation. Referring now to FIG. 2, there is shown a block representation of a feedback control system 100. The time between measuring the actual output 120 from process 150 and the output of combiner 130 being fed back to the controller 140 is shown by feedback delay (dead time) 160. Where process 150 is embodied as a chemical plant for example, controller 140 may be embodied as a PID (Proportional, Integral, Derivative) controller. A PID controller compares a measured value from a process with a reference setpoint value. The difference (or “error” signal) is then processed to calculate a new value for a manipulated process output that brings the process measured value back to its desired setpoint. A PID controller can adjust process outputs based on the history and rate of change of the error signal. A PID controller's correction is calculated from the error in three ways: canceling out the current error directly (Proportional), the amount of time the error has continued uncorrected (Integral), and anticipating the future error from the rate of change of the error over time (Derivative).

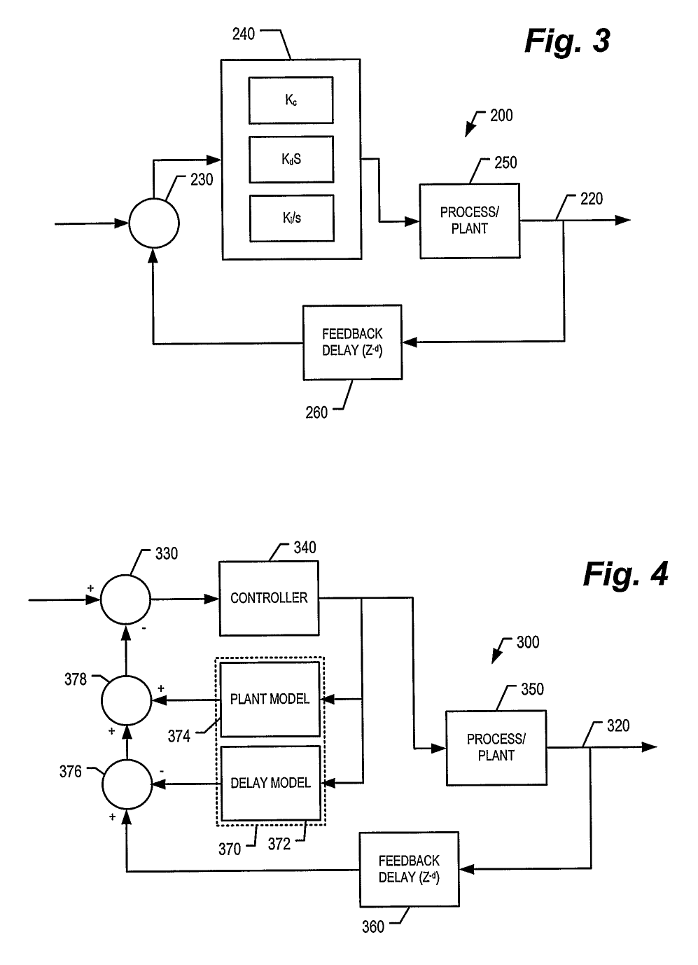

Referring now to FIG. 3, there is shown a block representation of a feedback control system 200 for digital multimedia content distribution. System 200 includes a PID controller 240. By design, a PID controller continues ramping up the controller's output as long as there is an error between the desired output 220 from channel 250 and the actual feedback signal 230. However, in the presence of dead time, the integrator (Kᵢ/s) may overcompensate. Based on the estimated dead time caused by the time delay in the feedback channel 260 in a video delivery system introduced by combiner 235, the PID controller 240 parameters may be tuned to essentially detune a PID controller to handle a dead time of D seconds. For non-limiting purposes of further explanation, a PID control loop can be tuned by adjusting the control parameters (Proportional, Integral, Derivative values) to obtain a desired control response. There are several methods for tuning a PID loop. One tuning method is to first set the integral (I) and derivative (D) values to zero and increase the proportional (P) value until the output of the loop oscillates. The I value may then be increased until the oscillation stops. And, finally the D value may be increased until the loop response is sufficiently fast.

However, PID type controllers have drawbacks when applied to systems having substantial dead time. For example, in a video delivery system, substantial dead time occurs when the feedback delay time is much longer than the time duration during which the channel enters a “bad” state (e.g. available bandwidth is considerably low, burst packet loss is considerably high). An alternative technique for controlling a system with large dead time is a Smith Predictor, as described in O. J. M Smith, “A CONTROLLER TO OVERCOME DEAD TIME.” ISA Journal. 6, pp. 28-33, 1959. The Smith Predictor was proposed for factory processes with long transport delays, such as catalytic crackers and steel mills, but it is believed this can be generalized to control processes that have long loop delays. It overcomes the problem of delayed feedback by using predicted future states of the output for control. It is believed a controller incorporating a Smith Predictor is well suited for adapting video streams in a wireless delivery system that experiences varying channel conditions.

Referring now to FIG. 4, there is shown a block representation of a feedback control system 300 that incorporates a Smith Predictor. System 300 includes a conventional feedback loop (from process or plant 350 output 320 through delayed feedback channel 360) back to controller 340. System 30Q also includes a second feedback loop (through process or plant model 370) that introduces two additional terms into the actual feedback at combiner 330. The first term represents an estimate of the plant 350 output 320 in the absence of delay (designated as the plant model component 374). The second term in the second feedback path is the estimate of the actual plant 350 output 320 expected in the presence of the feedback delay (designated delay model 372). Where the second loop includes an accurate representation of process or plant delay (feed-forward and feedback delays), it serves to delay the output from controller 340 to match the delay feedback from the periphery, and these two temporally matched signals normally cancel out (due to combiners 376, 378). The remaining signal substantially represents the actual output estimate from the conventional feedback loop (through delay 360) without the delay. In other words, if the model 370 is accurate in representing the behavior of process or plant 350, its output will be a dead time-free version of the actual plant 350 output 320. Predictive control for dead-time compensation is implemented using both plant and delay models. In this manner, statistically accurate models enable compensation of the delay time caused in the feedback channel so as to effectively negate the dead time error at the controller.

In a video delivery system, model 370 is equivalent to a model of a communication channel including feedback delay time. For non-limiting purposes of further explanation, predictable for purposes hereof means statistically correct. Thus, wireless network conditions are not entirely unpredictable. Basically, a model of the wireless network, such as a two-stage Markov-based channel model, or other more complicated models, such as Stochastic Channel Models may be used in model 370, which incorporate both the channel and delay models.

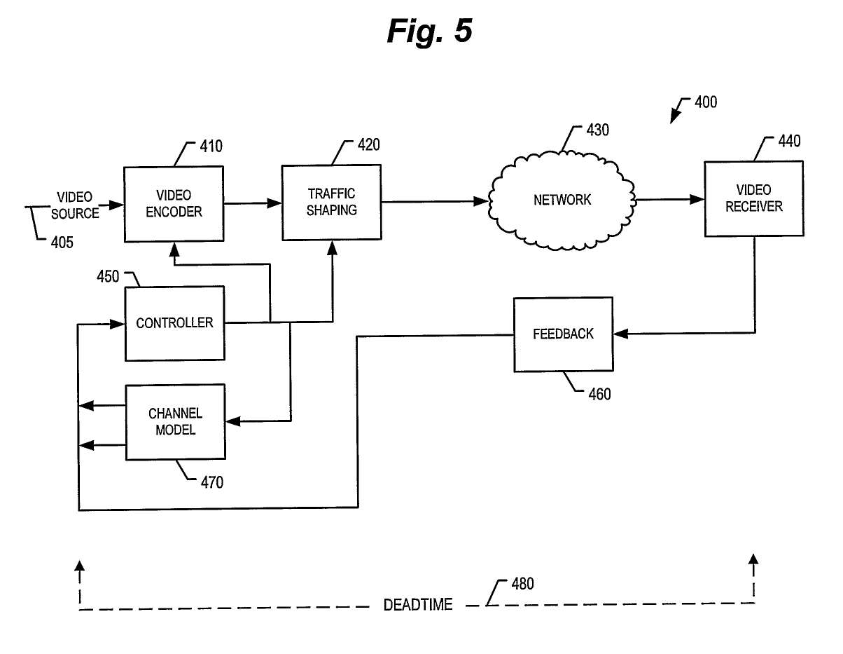

A block diagram of an end-to-end video delivery system 400 including an embedded Smith Predictor is shown in FIG. 5. System 400 generally includes a video encoder 410, traffic shaping unit 420, controller 450 and model 470, that may all be embodied in a server, for example. “Server”, as used herein, generally refers to a computing device that is connected to a network and manages network resources. A server may be a dedicated collection of computing hardware and/or software components, meaning that they perform no other tasks besides their server tasks, or may refer to hardware and/or software components that are managing resources rather than the entire computing device. A server generally includes, and/or uses, a processor. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., a computer program incorporating code) from memory and decodes and executes them, calling on the ALU when necessary. “Memory”, as used herein, refers generally to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit, e.g. an integrated circuit (IC), including a processor. The server may alternatively be embodied as an Application Specific Integrated Circuit (ASIC), for example.

System 400 also generally includes a network 430 and feedback channel 460, which may both be embodied as an IP network, for example. “Network”, as used herein, generally refers to a group of two or more computing devices linked together, including wired and wireless networks.

System 400 also includes a receiver 440, that may be embodied in a client, for example. “Client”, as used herein, generally refers to an application that runs on a computing device and relies on a server to perform some operations. The client may be embodied as a processor incorporating device, or as an Application Specific Integrated Circuit (ASIC), for example.

In one non-limiting embodiment, the server may take the form of a head-end of a video distribution system, the network may take the form of the data transport mechanism of the video distribution network, and the client may take the form of one or more applications serving as the consumer of the video distribution network, such as a digital set-top box, a smart-card or a personal computer (PC), all by way of non-limiting example only. By way of further, non-limiting example, where the video distribution network embodies a cable system, the controller and channel model, in combination with the encoder and traffic shaper may be located at the cable network head-end. Where the video distribution network embodies an xDSL network, they may be located at a telecommunications system central office.

Referring still to FIG. 5, video encoder 410 receives digital multimedia content from a source 405, and feeds traffic shaping unit 420. Such a traffic shaping unit may be embodied as a Leaky Bucket algorithm being executed by suitable computational resources, for example. Traffic shaping, e.g., a leaky-bucket implementation, is used to control the rate at which traffic is sent to network 430.

Data from shaping unit 420 is transported to receiver 440 across network 430, which experiences time-varying transport conditions. Receiver 440 in turn provides the multimedia content to a content consumer, such as a television. Receiver 440 also determines parameters associated with network 430, and provides them to controller 450 via feedback channel 460. Where network 430 takes the form of an IP network, for example, the feedback information may be encapsulated in a real-time control protocol, such as the Real-Time Streaming Protocol (RTSP). Controller 450 uses a predictor function, such as the Smith Predictor configuration, incorporating channel model 470 to provide adaptive feedback to video encoder 410 and traffic shaping unit 420. Encoder 410, responsively to the output of controller 450, may for example alter quantization parameters of data output therefrom. Traffic shaping unit 420 may for example alter error correction component(s), such as Forward Error Correction (FEC) component(s) of data output therefrom in response to controller 450.

More advanced controller(s) may be used, such as a non-linear controller and/or a fuzzy logic controller. This invention may be applied to both wired and wireless channels for video delivery.

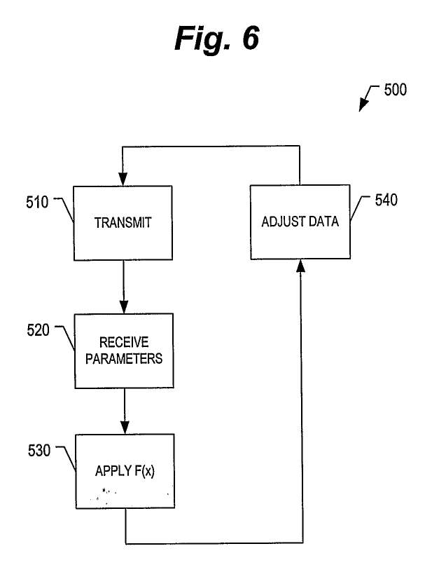

Referring now to FIG. 6, there is shown a flow diagram of a process 500 suitable for controlling transmission of video data in a network, such as a wireless network. Process 500 includes transmitting video data to a receiver via the network at block 510. Channel parameter information measured by the receiver is received at block 520. At least one predictive function is applied to the channel parameter information to compensate for delay times in receiving the channel parameter information from the receiver, and at least one feedback function is generated at block 530. Finally, video data to be transmitted in response to the feedback function is adjusted to compensate for network conditions at block 540. For example, one or more quantization parameters of a data encoder may be altered at block 540. In addition to, or in lieu thereof, a traffic shaper may alter error correction component(s), such as forward error correction component(s) of data output therefrom at block 540.

As discussed herein, dead-time (e.g., 480, FIG. 5) occurring in a video delivery system may result in a delayed controlling signal for a video transmitter. By employing a controller in the loop and adapting the controller based on the communication channel model, this dead time may be overcome in the channel parameter feedback loop. Thus this mechanism provides an accurate means to adaptively adjust a video encoder and traffic shaping device in the video transmitter to achieve the optimal adaptation of the video stream to cope with the time-varying nature of a wireless communication channel, for example in a wireless local area network WLAN that is compliant with, including, but not limited to, IEEE 802.11 standards, or Hiperlan 2.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

1. A method for controlling transmission of video data in a network, comprising:
transmitting video data to a receiver via the network;
receiving channel parameter information measured by the receiver;
applying a predictive function to the channel parameter information to compensate for delay times in receiving the channel parameter information from the receiver, and generating a feedback function; and
adjusting the video data to be transmitted in response to the feedback function to compensate for network conditions.

2. The method of claim 1, wherein the predictive function is based on a statistical model of the network conditions.

3. The method of claim 1, wherein the network is a WLAN.

4. The method of claim 1, wherein the adjusting step comprises adjusting quantization parameters in the video encoder.

5. The method of claim 1, wherein the adjusting step comprises adjusting error correction data included in the video data stream.

6. A system for controlling transmission of video data in a network, comprising:
a transmitter for generating a video data stream and transmitting the video data stream over the network;
a receiver for receiving the video data stream over the network, the receiver measuring channel parameter information associated with the transmission and transmitting the channel parameter information to the transmitter via a feedback channel, the transmitter including a controller for receiving the channel parameter information from the receiver, the controller applying a predictive function to the channel parameter information to generate a feedback function and adjusting the video data stream in response to the predictive function and channel parameter information.

7. The system of claim 6, wherein the predictive function is based on a statistical model of the network conditions.

8. The system of claim 6, wherein the network is a WLAN.

9. The system of claim 6, wherein the controller adjusts quantization parameters in the video encoder.

10. The system of claim 6, wherein the controller adjusts error correction data included in the video data stream.

11. A transmitter for providing streaming video to a receiver via a network, the transmitter comprising:
an encoder having an output;
a traffic shaper having an input coupled to the output of the encoder;
a controller coupled to at least one of the encoder and traffic shaper; and,
wherein, the controller predictively modifies the operation of at least one of the encoder and traffic shaper according to a channel model and at least one actual parameter of the network.

12. The transmitter of claim 11, wherein the controller predictively modifies based on a statistical model of the network conditions.

13. The transmitter of claim 12, wherein the controller is coupled to both the encoder and traffic shaper.

14. The transmitter of claim 13, wherein the controller modifies the operation of both the encoder and traffic shaper.

15. The transmitter of claim 11, wherein the at least one actual parameter of the network comprises at least one parameter indicative of channel quality.

16. The transmitter of claim 11, wherein the at least one actual parameter of the network comprises at least one parameter indicative of a bit error rate.

17. The transmitter of claim 11, wherein the model comprises a plurality of models, wherein one of the models in indicative of network feed forward delay and another of the models is indicative of network feed-back delay.

18. The transmitter of claim 11, further comprising a source of digital video data coupled to the encoder.

19. The transmitter of claim 11, wherein the network is a WLAN.
